(19) United States
(12) Patent Application Publication
(10) Pub. No.: US 2020/0334598 A1
(43) Pub. Date: Oct. 22, 2020

(54) AUTOMATED SUMMARY SYSTEM COMPUTER SERVER ASSOCIATED WITH A RISK RELATIONSHIP ATTRIBUTE VALUE REVIEW

(71) Applicants: Danah L. Prignano, Hartford, CT (US); Marie C. Norcia, Spencer, MA (US); Matthew Timothy Moore, Chicago, IL (US); Michael Peretto, Wethersfield, CT (US)

(72) Inventors: Danah L. Prignano, Hartford, CT (US); Marie C. Norcia, Spencer, MA (US); Matthew Timothy Moore, Chicago, IL (US); Michael Peretto, Wethersfield, CT (US)

(21) Appl. No.: 16/387,281

(22) Filed: Apr. 17, 2019

(51) Int. Cl. G06Q 10/06; G06F 16/248; G06F 16/25; G06F 16/2457; G06Q 40/08; G06F 17/24

(52) U.S. Cl. CPC G06Q 10/0635; G06Q 10/06375; G06F 16/248; G06F 17/246; G06F 16/2457; G06Q 40/08; G06F 16/252

(57) ABSTRACT

A risk relationship data store may contain electronic records representing a plurality of risk relationships with an enterprise and, for each risk relationship, an electronic record identifier and a set of attribute values. An automated risk relationship attribute value review platform may receive an indication of a selected risk relationship from a remote administrator device and access the information in the risk relationship data store associated with the selected risk relationship. An automated risk relationship attribute value review may be performed on the accessed information to generate detailed risk relationship attribute review data. An automated summary system computer server may then receive the detailed risk relationship attribute review data and automatically create summarized risk relationship attribute review information based at least in part on the detailed risk relationship attribute review data. The summarized risk relationship attribute review information may then be transmitted to the remote administrator device.

### BACKGROUND

An enterprise might enter into risk relationships associated with an entity (e.g., as a form of risk management). For example, an insurer might issue insurance policies (e.g., workers' compensation, automobile liability, automobile property damage, general liability insurance, etc.) in connection with an employer and a set of employees. In some cases, the risk relationships may be associated with attribute values (e.g., payroll amounts, employee job classifications, etc.) including a resource value such as an insurance premium.

Note that when an account purchases an insurance policy, the premium may be estimated based on information provided about the business operations and exposure. As changes occur throughout a policy term, your payroll, the actual sales and operations may fluctuate from those initial predictions. A “premium audit” may help ensure that the premium paid to an insurer over the course of the policy term is based on the actual business exposures. The premium audit may involve reviewing information and documentation pertaining to the business during the policy term. In particular, as a policy term ends, the account may receive a communication about a required premium audit. Premium audits may be performed, for example, on workers' compensation policies because workers' compensation premiums are largely based on payroll estimates and employee job classifications which can change throughout the policy term resulting in over or underpayment of premium. After the audit information is submitted to the insurer, the account may receive a Statement of Premium Adjustment indication whether it is owed a refund or if additional premium is due for the coverage period.

Explaining how the actual insurance premium (as opposed to the estimated premium) is calculated, however, can be a confusing and difficult process. An account might be associated with multiple types of insurance policies that cover multiple geographic regions (e.g., U.S. states) further complicating how changes to job classifications, payroll amounts, etc. impacted the actual insurance premium. In some cases, an enterprise might use supporting documents, such as spreadsheet data, to explain how the actual insurance premium was calculated. Such an approach, however, can require an excessive amount of information and allow for minimal or no system integration to help utilize the data efficiently. Moreover, it can be difficult to aggregate and analyze information about multiple types of insurance policies, geographic regions, etc. It would be desirable to provide systems and methods to facilitate the use, summary, and analysis of electronic records associated with a risk management attribute value review in a way that efficiently provides more easily understood and communicated results.

### SUMMARY OF THE INVENTION

According to some embodiments, systems, methods, apparatus, computer program code and means are provided with an automated summary system computer server associated with a risk relationship attribute value review for an enterprise. A risk relationship data store may contain electronic records representing a plurality of risk relationships with an enterprise and, for each risk relationship, an electronic record identifier and a set of attribute values. An automated risk relationship attribute value review platform may receive an indication of a selected risk relationship from a remote administrator device and access the information in the risk relationship data store associated with the selected risk relationship. An automated risk relationship attribute value review may be performed on the accessed information to generate detailed risk relationship attribute review data. An automated summary system computer server may then receive the detailed risk relationship attribute review data and automatically create summarized risk relationship attribute review information based at least in part on the detailed risk relationship attribute review data. The summarized risk relationship attribute review information may then be transmitted to the remote administrator device.

Some embodiments comprise: means for receiving, at an automated risk relationship attribute value review platform, an indication of a selected risk relationship from a remote administrator device associated with the enterprise; means for accessing, by the automated risk relationship attribute value review platform, information in a risk relationship data store associated with the selected risk relationship, wherein the risk relationship data store contains electronic records associated with the enterprise and, for each risk relationship, an electronic record identifier and a set of attribute values including at least one resource value; means for performing, by the automated risk relationship attribute value review platform, an automated risk relationship attribute value review on the accessed information to generate detailed risk relationship attribute review data; means for receiving the detailed risk relationship attribute review data at the automated summary system computer server; means for automatically creating, by the automated summary system computer server, summarized risk relationship attribute review information based at least in part on the detailed risk relationship attribute review data; and means for transmitting, by the automated summary system computer server, the summarized risk relationship attribute review information to the remote administrator device associated with the enterprise.

In some embodiments, a communication device associated with an automated summary system computer server exchanges information with remote devices in connection with an interactive graphical user interface (such as a spreadsheet application). The information may be exchanged, for example, via public and/or proprietary communication networks.

A technical effect of some embodiments of the invention is an improved and computerized way to facilitate the use, summary, and analysis of electronic records associated with a risk management attribute value review in a way that efficiently provides more easily understood and communicated results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a system in accordance with some embodiments.

FIG. 2 illustrates a method according to some embodiments of the present invention.

FIG. 3 is a more detailed block diagram of an insurance system in accordance with some embodiments.

FIG. 4 illustrates an information flow associated with a spreadsheet application according to some embodiments of the present invention.

FIG. 5 is an example of an audit comparison sheet in accordance with some embodiments.

FIG. 6 is an example of a display a statement of final adjustment according to some embodiments of the present invention.

FIG. 7 illustrates supporting information for a particular geographic location in accordance with some embodiments.

FIGS. 8A through 8C are an example of a workers' compensation balanced audit sheet according to some embodiments of the present invention.

FIGS. 9A through 9C are an example of a workers' compensation surcharge breakdown sheet in accordance with some embodiments.

FIGS. 10A through 10C are an example of an automobile liability balanced audit sheet according to some embodiments of the present invention.

FIGS. 11A through 11C are an automobile property damage balanced audit sheet in accordance with some embodiments.

FIG. 12 is a block diagram of an apparatus in accordance with some embodiments of the present invention.

FIG. 13 is a portion of a tabular insurance database according to some embodiments.

FIG. 14 illustrates a tablet computer displaying a premium audit summary display according to some embodiments.

### DETAILED DESCRIPTION

The present invention provides significant technical improvements to facilitate electronic messaging and dynamic data processing. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the area of electronic record attribute update, utilization, and/or analysis by providing benefits in data accuracy, data availability, data comprehension, data analysis, and data integrity and such advances are not merely a longstanding commercial practice. The present invention provides improvement beyond a mere generic computer implementation as it involves the processing and conversion of significant amounts of data in a new beneficial manner as well as the interaction of a variety of specialized client and/or third-party systems, networks, and subsystems. For example, in the present invention information may be processed, updated, and analyzed via a back-end-end application server to accurately improve the exchange of information, thus improving the overall efficiency of the system associated with message storage requirements and/or bandwidth considerations (e.g., by reducing the number of messages that need to be transmitted via a network, by improving response times by automatically creating and summarizing information, and/or by creating more complete and/or accurate documents). Moreover, embodiments associated with collecting accurate information might further improve risk values, predictions of risk values, allocations of resources, electronic record processing decisions, etc.

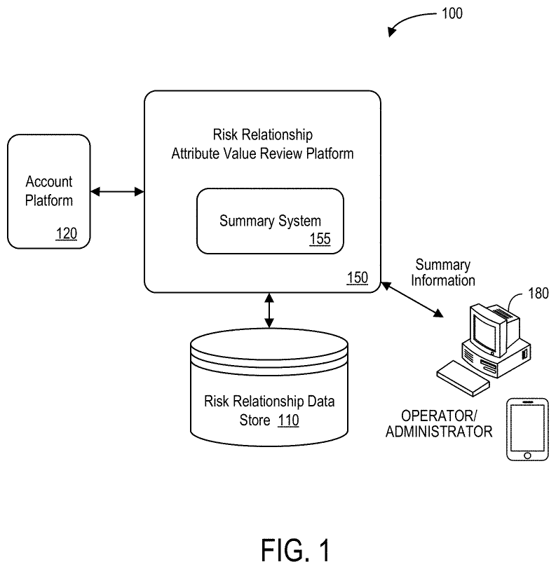

In some cases, a resource value associated with an enterprise system may depend at least in part on attribute values of electronic records representing a plurality of risk associations with an enterprise system. For example, the resource value might tend to increase when a specific type of attribute value increases (or decrease when another type of attribute value increases). Explaining how various factors impact a resource value, however, can be a time consuming and difficult process for a client, especially when a substantial number of electronic records, geographic locations, and/or other attribute variables may influence the behavior of the system. To address this issue, FIG. 1 is a high-level block diagram of a system 100 according to some embodiments of the present invention. In particular, the system 100 includes a risk relationship attribute value review platform 150 that may access information in a risk relationship data store 110 (e.g., storing a set of electronic records representing risk associations, each record including, for example, one or more risk relationship identifiers, payroll data, job classification, attribute variables, resource values, etc.). The risk relationship attribute value review platform 150 may also exchange information with an account platform 120 to verify, update, and/or utilize the electronic records. The risk relationship attribute value review platform 150 may also exchange information with a remote operator or administrator device 180 (e.g., via a firewall). According to some embodiments, an interactive graphical user interface (such as a spreadsheet application) platform of the risk relationship attribute value review platform 150 (and, in some cases, third-party data) may facilitate document creation, decisions, predictions, and/or the display of summary results via one or more remote administrator displays or portals (e.g., to gather additional information about an account). A summary system 155 may summarize information generated by an attribute value review for a particular account. After a review of the summary information, the risk relationship attribute value review platform 150 may adjust data in the risk relationship data store 110, automatically create a new risk relationship document, generate electronic messages or calendar events, etc. Note that the risk relationship attribute value review platform 150 and/or any of the other devices and methods described herein might be associated with a third party, such as company that performs a service for an enterprise.

The risk relationship attribute value review platform 150 and/or the other elements of the system 100 might be, for example, associated with a Personal Computer (“PC”), laptop computer, smartphone, an enterprise server, a server farm, and/or a database or similar storage devices. According to some embodiments, an “automated” risk relationship attribute value review platform 150 (and/or other elements of the system 100) may facilitate updates and utilization of electronic records in the risk relationship data store 110. As used herein, the term “automated” may refer to, for example, actions that can be performed with little (or no) intervention by a human.

As used herein, devices, including those associated with the risk relationship attribute value review platform 150 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a BLUETOOTH™ network, a wireless LAN network, and/or an Internet Protocol (“IP”) network such as the Internet, an intranet, or an extranet. Note that any devices described herein may communicate via one or more such communication networks.

The risk relationship attribute value review platform 150 may store information into and/or retrieve information from the risk relationship data store 110. The risk relationship data store 110 might, for example, store electronic records representing a plurality of risk associations, each electronic record having a set of attribute values. The risk relationship data store 110 may also contain information about prior and current interactions with parties, including those associated with various account platforms 120 and remote devices 180. The risk relationship data store 110 may be locally stored or reside remote from the risk relationship attribute value review platform 150. As will be described further below, the risk relationship data store 110 may be used by the risk relationship attribute value review platform 150 in connection with an interactive user interface to update electronic records. Although a single risk relationship attribute value review platform 150 is shown in FIG. 1, any number of such devices may be included. Moreover, various devices described herein might be combined according to embodiments of the present invention. For example, in some embodiments, the risk relationship attribute value review platform 150 and a document or image server might be co-located and/or may comprise a single apparatus.

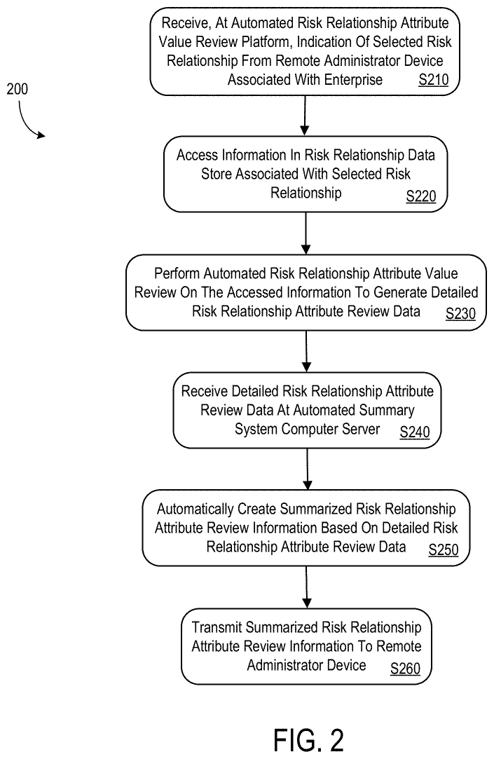

Note that the system 100 of FIG. 1 is provided only as an example, and embodiments may be associated with additional elements or components. According to some embodiments, the elements of the system 100 automatically transmit summarized information associated with an interactive user interface display over a distributed communication network. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, an automated risk relationship attribute value review platform may receive an indication of a selected risk relationship from a remote administrator device associated with the enterprise. For example, an insurance policy that needs to undergo a premium audit may be selected. At S220, the automated risk relationship attribute value review platform may access information in a risk relationship data store associated with the selected risk relationship. The risk relationship data store may contain, for example, electronic records associated with the enterprise and, for each risk relationship, an electronic record identifier and a set of attribute values including at least one resource value (e.g., an insurance premium amount). At S230, the automated risk relationship attribute value review platform may perform an automated risk relationship attribute value review on the accessed information to generate detailed risk relationship attribute review data. The attribute value review might include, for example, updating employee information, owner information, payment information, business information (e.g., general ledger data, sales journal data, cash receipts, and/or sales tax records), etc. associated with the account.

At S240, the detailed risk relationship attribute review data is received at an automated summary system computer server. At S250, the automated summary system computer server may automatically create summarized risk relationship attribute review information based at least in part on the detailed risk relationship attribute review data. The summary process may be performed in accordance with any of the embodiments described herein. According to some embodiments the automated summary system computer service utilizes a spreadsheet application, such as the EXCEL® spreadsheet application available from MICROSOFT® CORPORATION, to help summarize the data. At S260, the automated summary system computer server may transmit the summarized risk relationship attribute review information to the remote administrator device associated with the enterprise and/or the account.

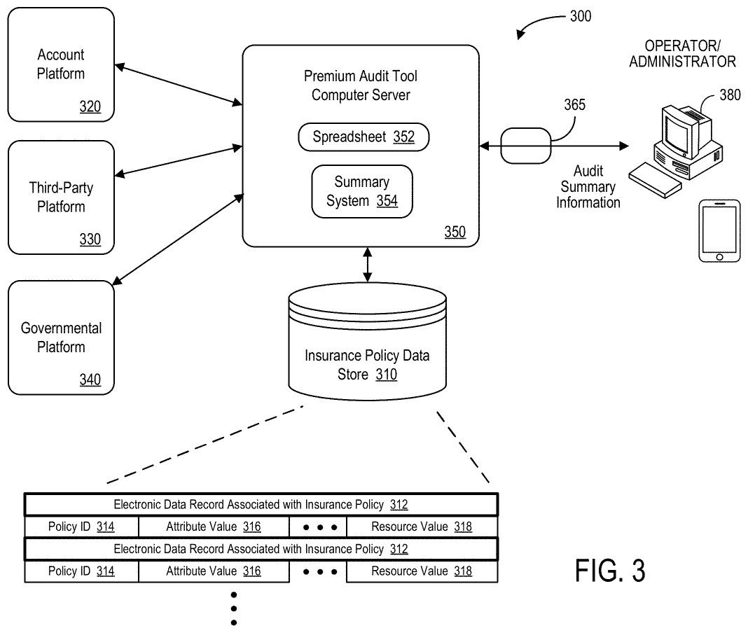

In this way, a system may let users create summary information associated with a risk relationship review or audit for an account of an enterprise. According to some embodiments, the “risk relationships” are associated with insurance policies and at least some attribute and resource values are associated with insurance programs. For example, FIG. 3 is a more detailed block diagram of a system 300 according to some embodiments. As before, the system 300 includes a premium audit tool computer server 350 that may access information in an insurance policy data store 310 (e.g., storing a set of electronic records 312 representing insurance policies, each record including, for example, one or more insurance policy identifiers 314, attribute variables 316, resource values 318 such as premiums, etc.). The premium audit tool computer server 350 may also retrieve information from an account platform 320 (e.g., with updated payroll data), a third-party platform 330 (e.g., to pre-populate some of the audit information), and/or a governmental platform 340 (e.g., a number of automobiles registered to a business based on a state's department of motor vehicle record information) to update or utilize the electronic records. The premium audit tool computer server 350 may also exchange information with a remote operator or administrator terminals 380 (e.g., via a firewall 365) to provide audit summary information. According to some embodiments, an interactive graphical user interface spreadsheet 352 and/or algorithm of the premium audit tool computer server 350 may facilitate document creation, decisions, predictions, and/or the display of results via one or more remote administrator computers 380.

The premium audit tool computer server 350 may process, according to some embodiments, information via a summary system 354. A user may then review the summary information and transmit updated information to the premium audit tool computer server 350. Based on the updated information, the premium audit tool computer server 350 may adjust or utilize data in the insurance policy data store 310 and automatically generate appropriate documents or summary reports. According to some embodiments, the premium audit tool computer server 350 may transmit information to an email server, workflow application, or calendar function (e.g., to generate reminders when an account needs to perform a certain action).

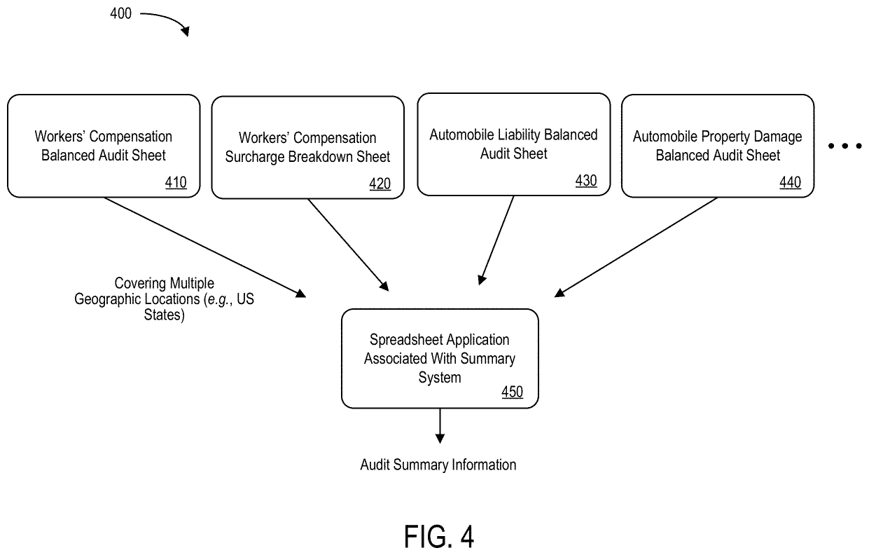

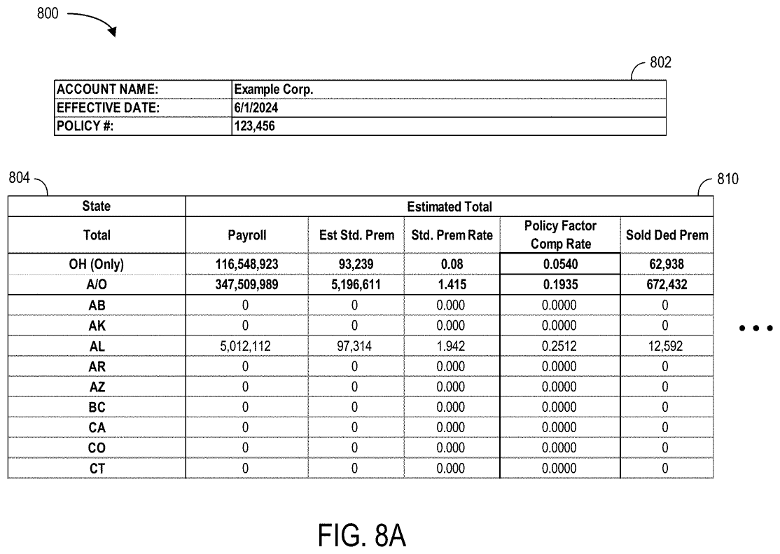

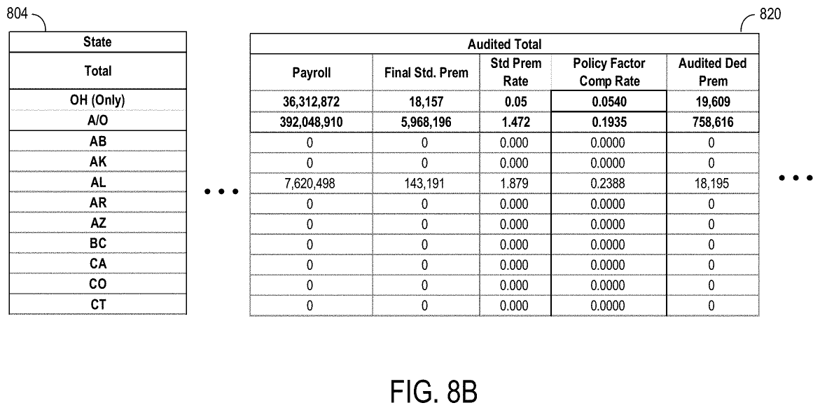

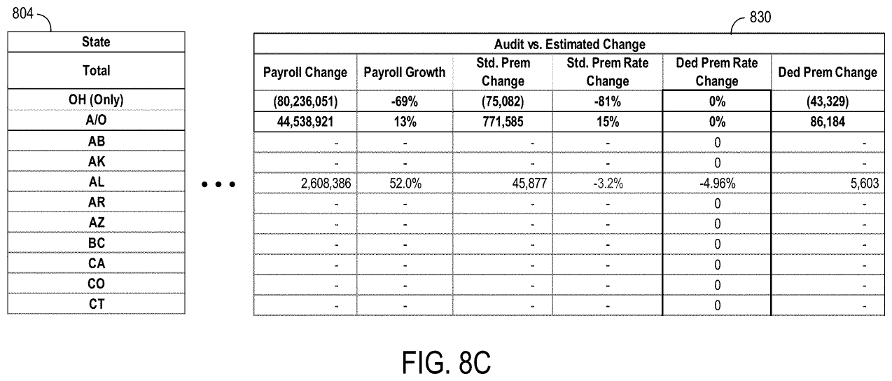

FIG. 4 illustrates an information flow 400 associated with a spreadsheet application according to some embodiments of the present invention. A spreadsheet application associated with a summary system 450 may receive a Workers' Compensation (“WC”) balanced audit sheet 410 that resulted from a premium audit process. The sheets provided to the spreadsheet application 450 may each cover multiple geographic locations (e.g., U.S. states). A detailed description of a workers' compensation balanced audit sheet 410 is provided with respect to FIGS. 8A through 8C (and the other premium audit process elements of FIG. 4 are likewise described in more detail herein). The spreadsheet application 450 may also receive a workers' compensation surcharge breakdown sheet 420, an Automobile Liability (“AL”) balanced audit sheet 430, an Automobile Property Damage (“APD”) balanced audit sheet 440, etc.

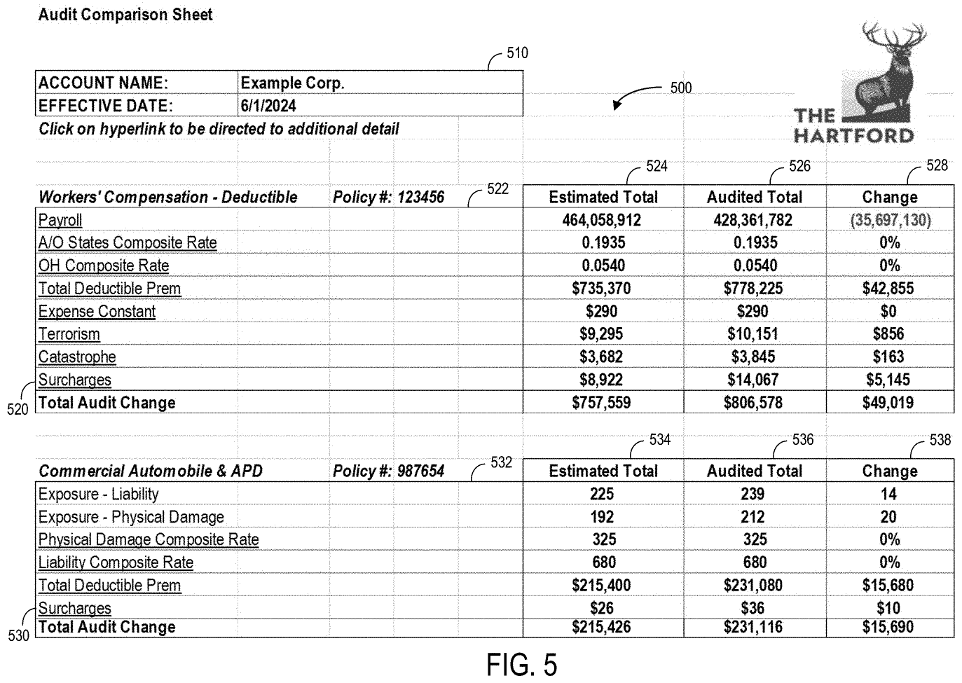

Based on the received information, the spreadsheet application 450 creates audit summary information. For example, FIG. 5 illustrates an audit comparison sheet 500 in accordance with some embodiments. The audit comparison sheet 500 includes an identification heading 510 including an account name and an effective date associated with one or more insurance policies. Workers' compensation deductible audit summary data 520 and commercial automobile and APD audit summary data 530 are also provided on the sheet 500. In particular, the workers' compensation deductible audit summary data 520 includes a line item description 522 (which may comprise a link selectable by a user to see further details and “drill down” into the data), an estimated total 524, an audited total 526, and a change 528. Similarly, the commercial automobile and APD audit summary data 530 includes a line item description 532 (which may comprise a link), an estimated total 534, an audited total 536, and a change 538.

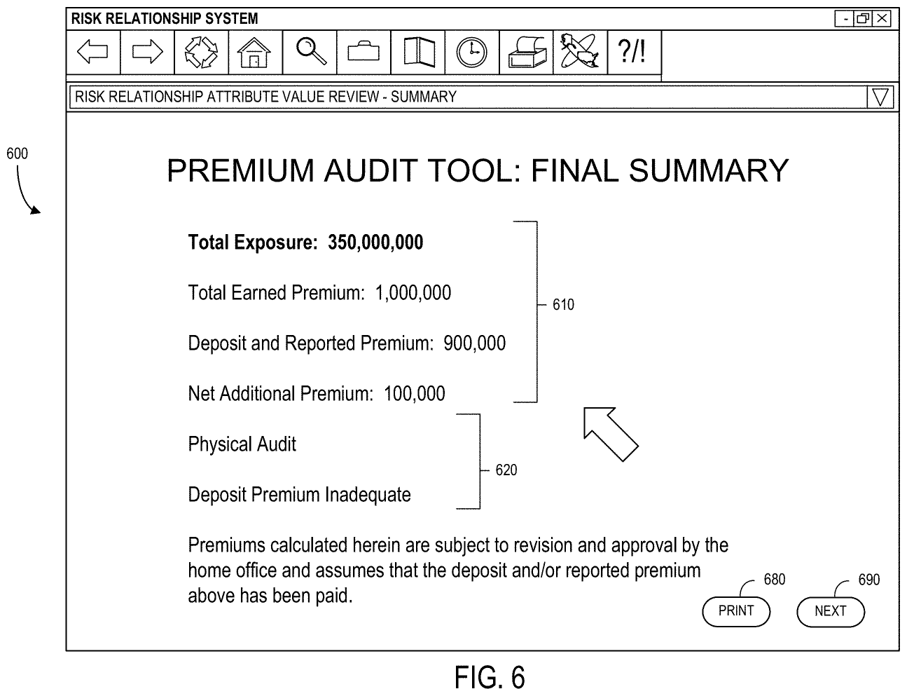

FIG. 6 is an example of display 600 for a statement of final adjustment according to some embodiments of the present invention. The display 600 might comprise, for example, a final summary of an insurance premium audit process. The display 600 includes summary values 610 (e.g., associated with a total exposure, a total earned premium, a paid premium, etc.) along with details describing how the the premium audit process was performed. Selection of a “Print” icon 680 may generate a paper version of the final summary. Selection of a “Next” icon 690 might navigate the user to other portions of a premium audit tool.

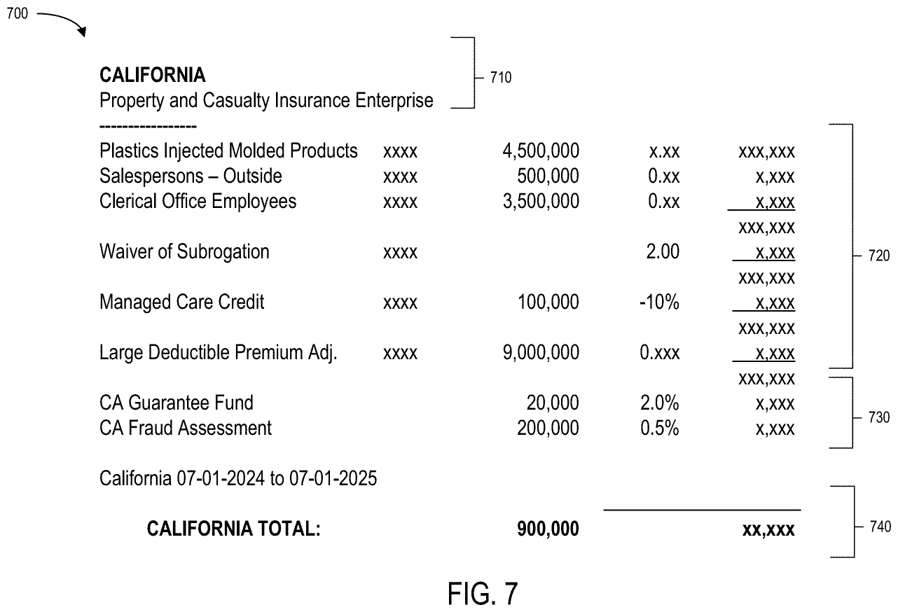

FIG. 7 illustrates supporting information 700 for a particular geographic location in accordance with some embodiments. In particular, the supporting information 700 is for “California” as indicated in a heading 710. According to some embodiments, the supporting information 700 includes further details 720 about an insurance policy premium audit (e.g., classification codes, waivers of subrogation, managed care credit values) along with surcharge information 730. Finally, the supporting information may further include total amounts 740 for that particular geographic region.

FIGS. 8A through 8C are an example of a workers' compensation balanced audit sheet 800 for an account indicated in a header 802 (along with an effective date and a policy number) according to some embodiments of the present invention. In particular, FIG. 8A illustrates estimated total values 810 for the sheet 800 broken down by state 804. The estimated total values 810 might include, for example, “Payroll,” “Est Std. Prem,” “Std. Prem Rate,” “Policy Factor Comp Rate,” and “Sold Ded Prem” values for the insurance policy. The “Policy Factor Comp Rate” may be associated with a composite rate that results in the audit sheet being automatically and dynamically “balanced.” Consider the first two entries in the audit sheet: Ohio only (“OH (Only)”) and all states except Ohio (“A/O”). Each has a specific composite rate that was agreed to when the policy was initially issued. Even when other values in the audit sheet are adjusted after audit, premium amounts are automatically and dynamically calculated such that these composite rates remain unchanged. These automatic, dynamic balancing calculations are one of the reasons why premium audit details are confusing to some accounts (and why the summary technique described herein may help an account better understand how changes to premium values are decided upon). FIG. 8B illustrates audited total values 820 for the sheet 800 broken down by state 804. The audited total values 820 might include, for example, “Payroll,” “Final Std. Prem,” “Std. Prem Rate,” “Policy Factor Comp Rate,” and “Audited Ded Prem” values for the insurance policy. FIG. 8C illustrates a comparison of audit and estimated values 830 for the sheet 800 broken down by state 804. The comparison of audit and total values 830 might include, for example, “Payroll Change,” “Payroll Growth,” “Std. Prem Change,” “Std. Prem Rate Change,” “Ded Prem Rate Change,” and “Ded Prem Change” values for the insurance policy. The sheet 800 of FIG. 8 might be considered “balanced,” for example, when values are dynamically and automatically readjusted to keep certain ratios consistent (e.g., associated with rates for a particular state).

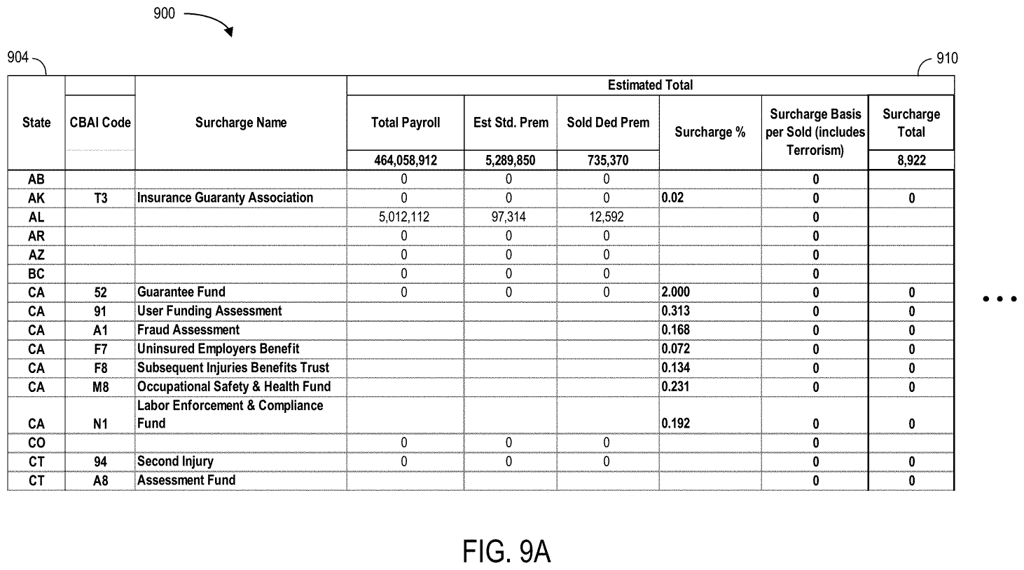

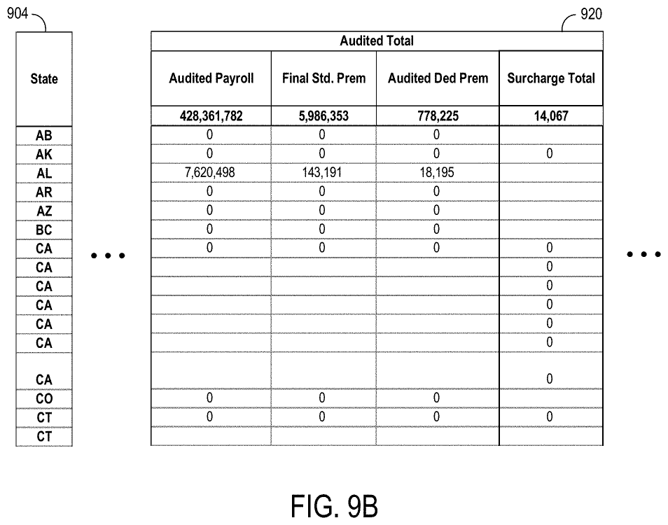

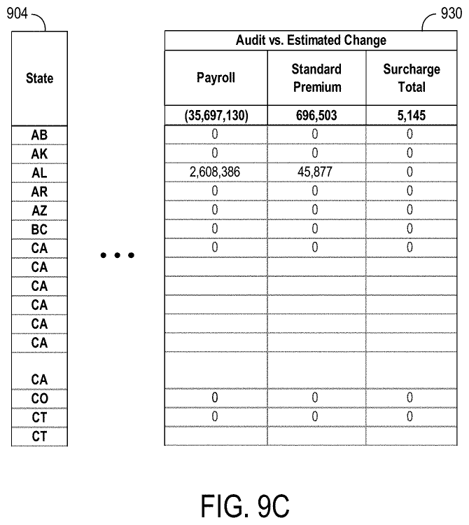

FIGS. 9A through 9C are an example of a workers' compensation surcharge breakdown sheet 900 in accordance with some embodiments. In particular, FIG. 9A illustrates estimated total values 910 for the sheet 900 broken down by state surcharge 904 along with a CBAI code and a name for each surcharge. The estimated total values 910 might include, for example, “Total Payroll,” “Est Std. Prem,” “Sold Ded Prem,” “Surcharge %,” “Surcharge Basis per Sold (includes Terrorism),” and “Surcharge Total” values for the insurance policy. FIG. 9B illustrates audited total values 920 for the sheet 900 broken down by state surcharge 904. The audited total values 920 might include, for example, “Audited Payroll,” “Final Std. Prem,” “Audited Ded Prem,” and “Surcharge Total” values for the insurance policy. FIG. 9C illustrates a comparison of audit and estimated total values 930 for the sheet 900 broken down by state surcharge. The comparison of audit and estimated total values 930 might include, for example, “Payroll,” “Standard Premium,” and “Surcharge Total” values for the insurance policy.

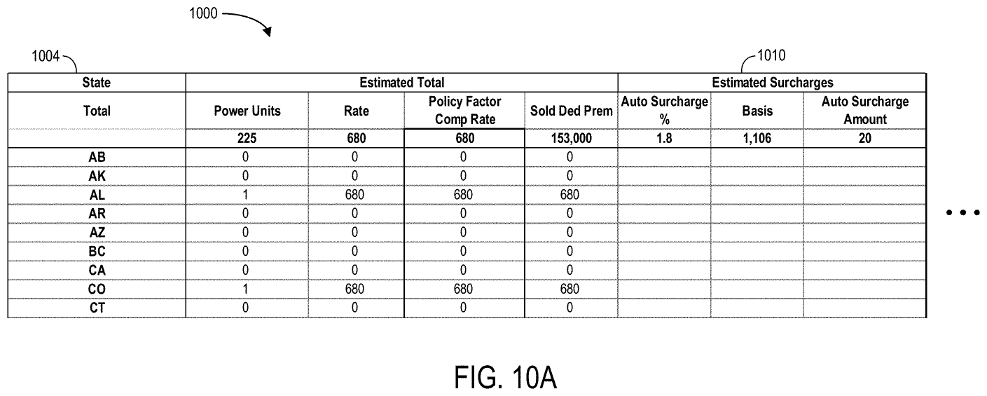

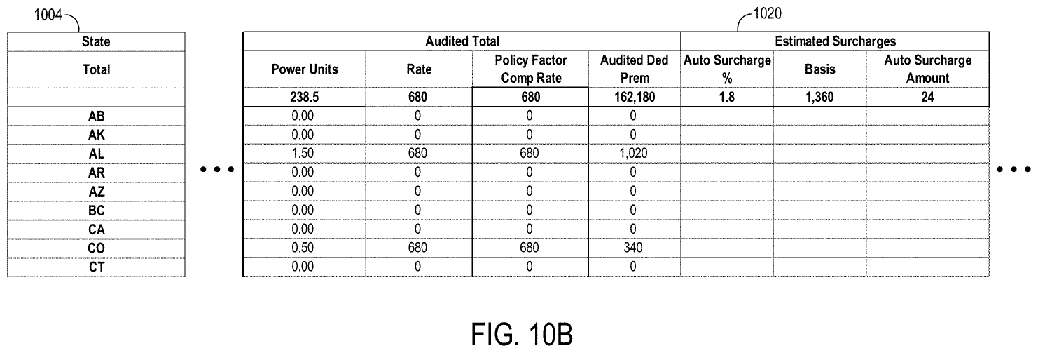

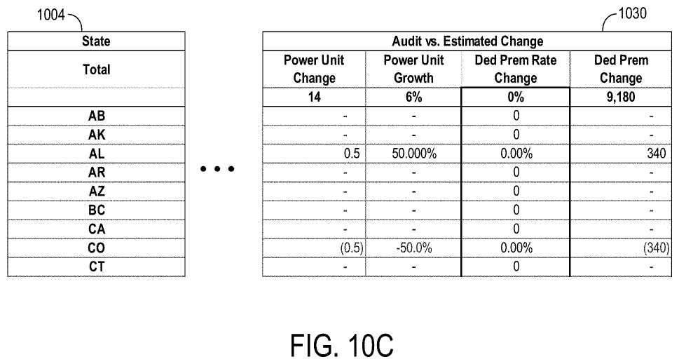

FIGS. 10A through 10C are an example of an automobile liability balanced audit sheet 1000 according to some embodiments of the present invention. In particular, FIG. 10A illustrates estimated total values and estimated surcharges 1010 for the sheet 1000 broken down by state 1004. The estimated total values might include, for example, “Power Units,” “Rate,” “Policy Factor Comp Rate,” and “Sold Ded Prem” values for the insurance policy. The estimated surcharges might include, for example, “Auto Surcharge %,” “Basis,” and “Auto Surcharge Amount.” FIG. 10B illustrates audited total values and estimated surcharges 1020 for the sheet 1000 broken down by state 1004. The audited total values might include, for example, “Rate,” “Policy Factor Comp Rate,” and “Policy Ded Prem” values for the insurance policy. The estimated surcharges might include, for example, “Auto Surcharge %,” “Basis,” and “Auto Surcharge Amount.” FIG. 10C illustrates a comparison of audit versus estimated change 1030 for the sheet 1000 broken down by state 1004. The comparison of audit and estimated change 1030 might include, for example, “Power Unit Change,” “Power Unit Growth,” “Ded Prem Rate Change,” and “Ded Prem Change” values for the insurance policy.

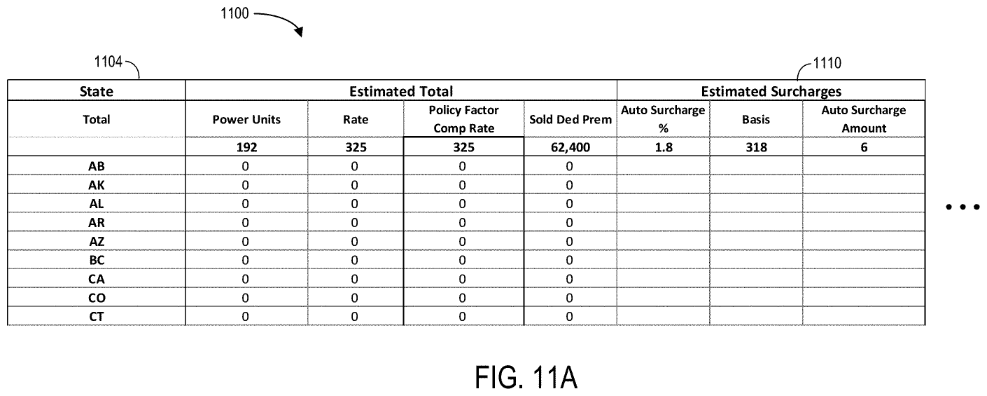

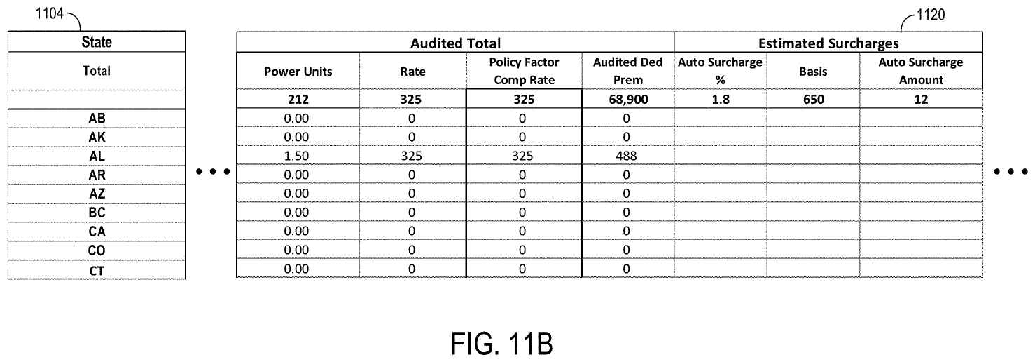

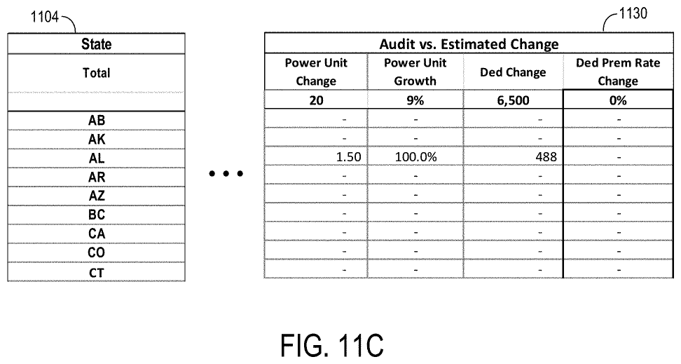

FIGS. 11A through 11C are an automobile property damage balanced audit sheet 1100 in accordance with some embodiments. In particular, FIG. 11A illustrates estimated total values and estimated surcharges 1110 for the sheet 1100 broken down by state 1104. The estimated total values might include, for example, “Power Units,” “Rate,” “Policy Factor Comp Rate,” and “Sold Ded Prem” values for the insurance policy. The estimated surcharges might include, for example, “Auto Surcharge %,” “Basis,” and “Auto Surcharge Amount.” FIG. 11B illustrates audited total values and estimated surcharges 1120 for the sheet 1100 broken down by state 1104. The audited total values might include, for example, “Power Units,” “Rate,” “Policy Factor Comp Rate,” and “Audited Ded Prem” values for the insurance policy. The estimated surcharges might include, for example, “Auto Surcharge %,” “Basis,” and “Auto Surcharge Amount.” FIG. 11C illustrates a comparison of audit versus estimated change 1130 for the sheet 1100 broken down by state 1104. The comparison of audit and estimated change 1130 might include, for example, “Power Unit Change,” “Power Unit Growth,” “Ded Change,” and “Ded Prem Rate Change” values for the insurance policy. Although specific sheets have been described in connection with FIGS. 8A through 11C, note that embodiments may include sheets for other types of insurance in addition to, or instead of, those described. For example, sheets associated with a general liability insurance policy might be similar in some respects to the automobile property damage balanced audit sheet 1100 (perhaps without being separated into geographic locations) and include a composite rate that is based on a sales value, a payroll value, an amount of square feet, etc.

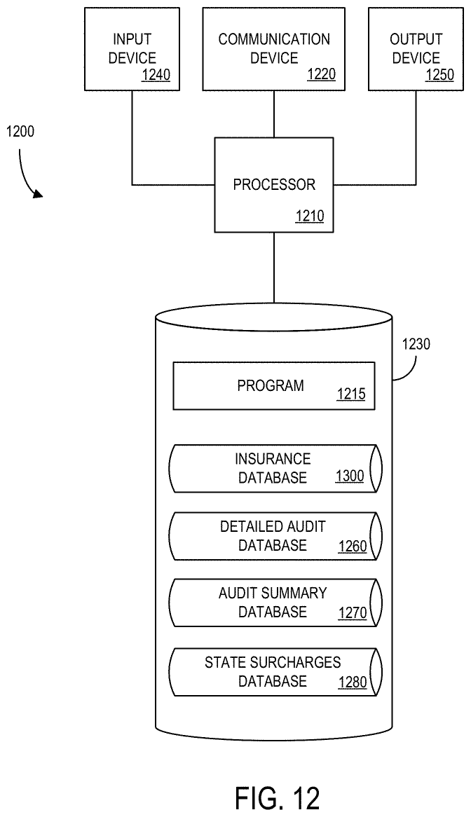

The embodiments described herein may be implemented using any number of different hardware configurations. For example, FIG. 12 illustrates an apparatus 1200 that may be, for example, associated with the systems 100, 300 described with respect to FIGS. 1 and 3, respectively. The apparatus 1200 comprises a processor 1210, such as one or more commercially available Central Processing Units (“CPUs”) in the form of one-chip microprocessors, coupled to a communication device 1220 configured to communicate via a communication network (not shown in FIG. 12). The communication device 1220 may be used to communicate, for example, with one or more remote administrator computers and or communication devices (e.g., PCs and smartphones). Note that communications exchanged via the communication device 1220 may utilize security features, such as those between a public internet user and an internal network of the insurance enterprise. The security features might be associated with, for example, web servers, firewalls, and/or PCI infrastructure. The apparatus 1200 further includes an input device 1240 (e.g., a mouse and/or keyboard to enter information about audit data summary rules or logic) and an output device 1250 (e.g., to output reports regarding account statistics and analytics).

The processor 1210 also communicates with a storage device 1230. The storage device 1230 may comprise any appropriate information storage device, including combinations of magnetic storage devices (e.g., a hard disk drive), optical storage devices, mobile telephones, and/or semiconductor memory devices. The storage device 1230 stores a program 1215 and/or a risk evaluation tool or application for controlling the processor 1210. The processor 1210 performs instructions of the program 1215, and thereby operates in accordance with any of the embodiments described herein. For example, the processor 1210 may access a risk relationship data store containing electronic records that represent a plurality of risk relationships with an enterprise and, for each risk relationship, an electronic record identifier and a set of attribute values including at least one resource value. The processor 1210 may then receive an indication of a selected risk relationship from a remote administrator device and perform attribute value review (e.g., a premium audit) to generate detailed risk relationship attribute review data. The processor 1210 may then automatically create summarized risk relationship attribute review information based at least in part on the detailed risk relationship attribute review data. The summarized risk relationship attribute review information may then be transmitted to the remote administrator device.

The program 1215 may be stored in a compressed, uncompiled and/or encrypted format. The program 1215 may furthermore include other program elements, such as an operating system, a database management system, and/or device drivers used by the processor 1210 to interface with peripheral devices.

As used herein, information may be “received” by or “transmitted” to, for example: (i) the automated summary system computer server 1200 from another device; or (ii) a software application or module within the automated summary system computer server 1200 from another software application, module, or any other source.

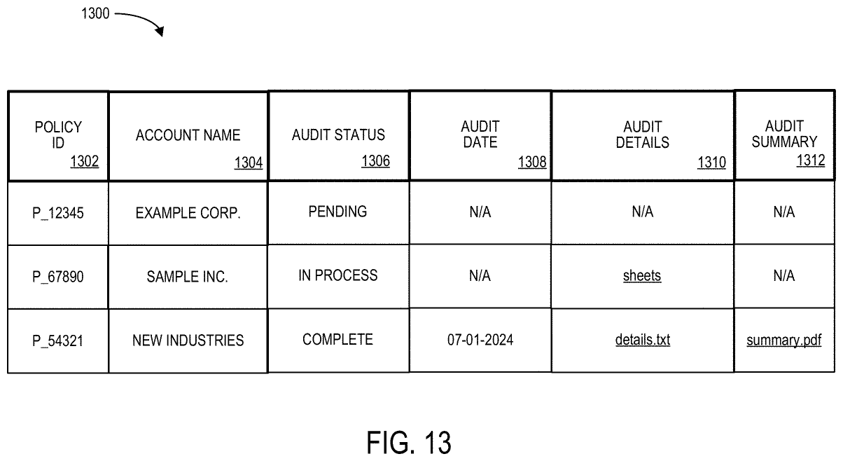

In some embodiments (such as shown in FIG. 12), the storage device 1230 further stores an insurance database 1300, a detailed audit database 1260 (e.g., storing the results of a premium audit process), an audit summary database 1270 (e.g., storing information similar to that described in connection with FIG. 5), and state surcharges database 1280. An example of a database that might be used in connection with the apparatus 1200 will now be described in detail with respect to FIG. 13. Note that the database described herein is only an example, and additional and/or different information may be stored therein. Moreover, various databases might be split or combined in accordance with any of the embodiments described herein. For example, the insurance database 1300 and the audit summary database 1270 might be combined and/or linked to each other within the program 1215.

Referring to FIG. 13, a table is shown that represents the insurance database 1300 that may be stored at the apparatus 1300 according to some embodiments. The table may include, for example, entries associated with insurance policy that have been (or will be) the subject of a premium audit process. The table may also define fields 1302, 1304, 1306, 1308, 1310, 1312 for each of the entries. The fields 1302, 1304, 1306, 1308, 1310, 1312 may, according to some embodiments, specify: a policy identifier 1302, an account name 1304, an audit status 1306, an audit date 1308, audit details 1310, and an audit summary 1312. The insurance database 1300 may be created and updated, for example, when a new insurance policy is issued, when an insurance policy is renewed, when a premium audit is performed for an account, etc.

The policy identifier 1302 may be, for example, a unique alphanumeric code identifying an insurance policy (e.g., workers' compensation, automobile liability, automobile property damage, general liability insurance, etc.) to an account identified by the account name 1304. The audit status 1306 might indicate that a premium audit is pending for that insurance policy, is in process, is complete, etc. The audit date might indicate when the premium audit was complete. The audit details 1310 might comprise data or a link to data generated by the premium audit, and the audit summary 1312 might represent information that summarizes the audit details 1310 in a simple and easy to understand fashion.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

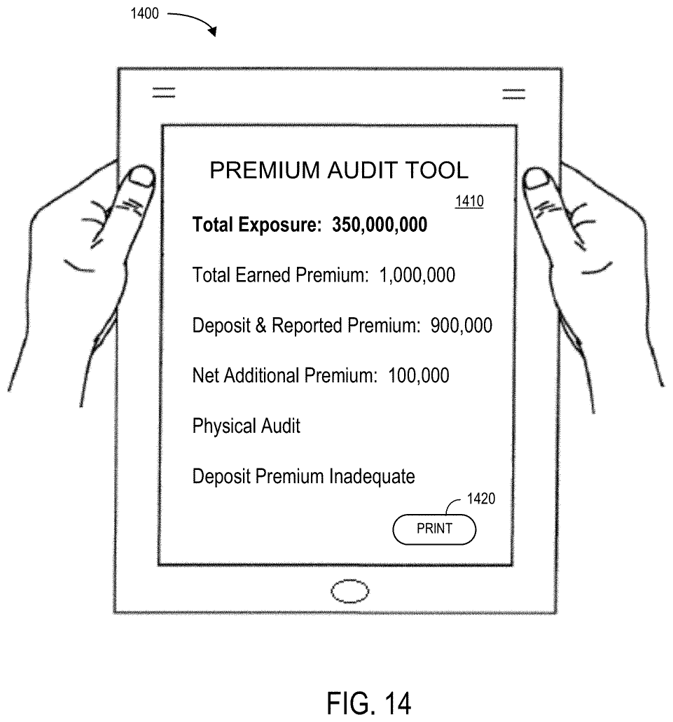

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to particular types of insurance policies, embodiments may instead be associated with other types of insurance policies in additional to and/or instead of the policies described herein (e.g., business insurance policies, health plans, etc.). Similarly, although certain attributes were described in connection some embodiments herein, other types of attributes might be used instead. Still further, the displays and devices illustrated herein are only provided as examples, and embodiments may be associated with any other types of user interfaces. For example, FIG. 14 illustrates a handheld tablet computer 1400 showing a premium audit tool summary display 1410 according to some embodiments. The premium audit tool summary display 1410 might include user-selectable data that can be selected or modified by a user of the handheld computer 1400 to provide more detailed insurance information associated with an insurance enterprise and/or to generate a physical result (e.g., via an icon 1420 to “Print” a paper copy of a summary report).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system with an automated summary system computer server associated with a risk relationship attribute value review for an enterprise, comprising:
(a) a risk relationship data store containing electronic records associated with the enterprise and, for each risk relationship, an electronic record identifier and a set of attribute values including at least one resource value;
(b) an automated risk relationship attribute value review platform, coupled to the risk relationship data store, programmed to:
(i) receive an indication of a selected risk relationship from a remote administrator device associated with the enterprise,
(ii) access the information in the risk relationship data store associated with the selected risk relationship, and
(iii) perform an automated risk relationship attribute value review on the accessed information to generate detailed risk relationship attribute review data;
(c) the automated summary system computer server, coupled to the automated risk relationship attribute value review platform, programmed to:
(i) receive the detailed risk relationship attribute review data,
(ii) automatically create summarized risk relationship attribute review information based at least in part on the detailed risk relationship attribute review data, and
(iii) transmit the summarized risk relationship attribute review information to the remote administrator device associated with the enterprise; and
(d) a communication port coupled to the automated summary system computer server to facilitate an exchange of data with the remote administrator platform to support a risk relationship attribute value review interface display via a distributed communication network.

2. The system of claim 1, wherein the risk relationship is associated with an insurance policy.

3. The system of claim 2, wherein the resource value is associated with an insurance premium amount.

4. The system of claim 3, wherein the automated risk relationship attribute value review platform is associated with a premium audit tool.

5. The system of claim 4, wherein the detailed risk relationship attribute review data includes information about a plurality of geographic locations.

6. The system of claim 5, wherein the detailed risk relationship attribute review data includes information about multiple types of insurance policies.

7. The system of claim 6, wherein at least one type of insurance policy is associated with at least one of: (i) workers' compensation insurance, (ii) commercial automobile liability insurance, (iii) automobile property damage insurance, and (iv) and general liability insurance.

8. The system of claim 4, wherein the detailed risk relationship attribute review data includes at least one of: (i) estimated total data, (ii) audited total data, and (iii) audited versus estimate change data.

9. The system of claim 8, wherein the detailed risk relationship attribute review data includes at least one of: (i) payroll data, (ii) premium data, (iii) composite rate data, and (iv) surcharge data.

10. The system of claim 4, wherein the summarized risk relationship attribute review data includes at least one of: (i) payroll data, (ii) composite rate data, (iii) deductible premium data, (iv) expense constant data, and (v) surcharge data.

11. A computerized method utilizing an automated summary system computer server associated with a risk relationship attribute value review for an enterprise, comprising:
receiving, at an automated risk relationship attribute value review platform, an indication of a selected risk relationship from a remote administrator device associated with the enterprise;
accessing, by the automated risk relationship attribute value review platform, information in a risk relationship data store associated with the selected risk relationship, wherein the risk relationship data store contains electronic records associated with the enterprise and, for each risk relationship, an electronic record identifier and a set of attribute values including at least one resource value;
performing, by the automated risk relationship attribute value review platform, an automated risk relationship attribute value review on the accessed information to generate detailed risk relationship attribute review data;
receiving the detailed risk relationship attribute review data at the automated summary system computer server;
automatically creating, by the automated summary system computer server, summarized risk relationship attribute review information based at least in part on the detailed risk relationship attribute review data; and
transmitting, by the automated summary system computer server, the summarized risk relationship attribute review information to the remote administrator device associated with the enterprise.

12. The method of claim 11, wherein the risk relationship is associated with an insurance policy, the resource value is associated with an insurance premium amount, and the automated risk relationship attribute value review platform is associated with a premium audit tool.

13. The method of claim 12, wherein the detailed risk relationship attribute review data includes information about a plurality of geographic locations and multiple types of insurance policies.

14. The method of claim 13, wherein at least one type of insurance policy is associated with at least one of: (i) workers' compensation insurance, (ii) commercial automobile liability insurance, (iii) automobile property damage insurance, and (iv) and general liability insurance.

15. The method of claim 14, wherein the detailed risk relationship attribute review data includes at least one of: (i) estimated total data, (ii) audited total data, and (iii) audited versus estimate change data.

16. The method of claim 15, wherein the detailed risk relationship attribute review data includes at least one of: (i) payroll data, (ii) premium data, (iii) composite rate data, and (iv) surcharge data.

17. A non-tangible, computer-readable medium storing instructions, that, when executed by a processor, cause the processor to perform a method utilizing an automated summary system computer server associated with a risk relationship attribute value review for an enterprise, the method comprising:
receiving, at an automated risk relationship attribute value review platform, an indication of a selected risk relationship from a remote administrator device associated with the enterprise;
accessing, by the automated risk relationship attribute value review platform, information in a risk relationship data store associated with the selected risk relationship, wherein the risk relationship data store contains electronic records associated with the enterprise and, for each risk relationship, an electronic record identifier and a set of attribute values including at least one resource value;
performing, by the automated risk relationship attribute value review platform, an automated risk relationship attribute value review on the accessed information to generate detailed risk relationship attribute review data;
receiving the detailed risk relationship attribute review data at the automated summary system computer server;
automatically creating, by the automated summary system computer server, summarized risk relationship attribute review information based at least in part on the detailed risk relationship attribute review data; and
transmitting, by the automated summary system computer server, the summarized risk relationship attribute review information to the remote administrator device associated with the enterprise.

18. The medium of claim 17, wherein the risk relationship is associated with an insurance policy, the resource value is associated with an insurance premium amount, and the automated risk relationship attribute value review platform is associated with a premium audit tool.

19. The medium of claim 12, wherein the detailed risk relationship attribute review data includes information about a plurality of geographic locations and multiple types of insurance policies.

20. The medium of claim 19, wherein at least one type of insurance policy is associated with at least one of: (i) workers' compensation insurance, (ii) commercial automobile liability insurance, (iii) automobile property damage insurance, and (iv) and general liability insurance.
